(19) United States
(12) Patent Application Publication
(10) Pub. No.: US 2026/0156362 A1
(43) Pub. Date: Jun. 4, 2026

(54) CONTROL APPARATUS AND METHOD, IMAGE CAPTURING APPARATUS, AND IMAGE CAPTURING SYSTEM

(71) Applicant: CANON KABUSHIKI KAISHA, Tokyo (JP)

(72) Inventor: YUSUKE JOTA, Kanagawa (JP)

(21) Appl. No.: 19/393,903

(22) Filed: Nov. 19, 2025

(30) Foreign Application Priority Data
Nov. 29, 2024 (JP) 2024-208884

(51) Int. Cl. H04N 23/68

(52) U.S. Cl. CPC H04N 23/687; H04N 23/6811; H04N 23/6812

(57) ABSTRACT

In a control apparatus that controls image stabilization using a first correction unit that actuates a correction lens included in an imaging optical system and a second correction unit that actuates an image sensor, a first acquisition unit acquires an amount of shake, a determination unit determines a calculation method for correction amounts that are for controlling the first and second correction units based on the amount of shake and a control method of the first and second correction units, a calculation unit calculates the correction amounts based on the amount of shake using the calculation method, a second acquisition unit acquires a representative motion vector based on a motion vector detected from images output from the image sensor, and a setting unit sets an acquisition method for acquiring the representative motion vector by the second acquisition unit based on the calculation method.

### BACKGROUND

### Field of the Technology

The present disclosure relates to a control apparatus and method, an image capturing apparatus, an image capturing system, and in particular to a technique for controlling detection of a motion vector in an apparatus that performs image stabilization.

### Description of the Related Art

In recent years, many image capturing apparatuses such as digital cameras and video cameras have been equipped with an image stabilization function that corrects shakes and other motions that occur in the image capturing apparatuses. This image stabilization function has made it possible to capture images with higher image quality.

There are two main types of image stabilization mechanisms in image capturing apparatuses. One is a method that reduces image blur by shifting an image stabilization lens relative to the optical axis of an imaging optical system (Optical Image Stabilization, hereafter referred to as “OIS”), and the other is a method that reduces image blur by shifting an image sensor relative to the optical axis of the imaging optical system (In Body Image Stabilization, hereafter referred to as “IBIS”).

Japanese Patent No. 6410431 discloses that the image stabilization mechanisms of these two types are actuated simultaneously to widen the correctable range of shake angles.

However, the relative movement between an image of a subject and an image sensor (the amount of blur of the subject in the image) caused by movement of the image capturing apparatus may vary depending on the image height, and this effect is particularly noticeable in a case where a wide-angle lens is used. Therefore, the optimal image stabilization amount varies depending on the image height. For example, image blur may be corrected for the subject in the central area of an image where the image height is small, while image blur may be noticeable for the subject in the peripheral area of the image where the image height is high. In this case, if motion vectors are detected using the image of the subject output from the image capturing apparatus, the motion vectors may not be detected accurately in the peripheral area where the image height is high compared to the central area where the image height is small. As a result, for example, when image stabilization is performed using detection results of the motion vector, the desired image stabilization effect may not be achieved.

However, the method disclosed in Japanese Patent No. 6410431 does not take into consideration any measures to address the problem that motion vectors cannot be detected with high accuracy in the peripheral area where the image height is high compared to the central area where the image height is small.

### SUMMARY

The present disclosure has been made in consideration of the above situation, and improves the accuracy of detecting motion vectors in a case where image stabilization is performed.

According to the present disclosure, provided is a control apparatus that controls image stabilization using a first correction unit that reduces image blur by actuating a correction lens included in an imaging optical system and a second correction unit that reduces image blur by actuating an image sensor that photoelectrically converts light incident via the imaging optical system and outputs an image signal, the apparatus comprising one or more processors and/or circuitry which function as: a first acquisition unit that acquires an amount of shake detected by a shake detection unit; a determination unit that determines a calculation method for correction amounts that are for controlling the first correction unit and the second correction unit based on the amount of shake and a control method of the first correction unit and the second correction unit; a calculation unit that calculates the correction amounts for the first correction unit and the second correction unit based on the amount of shake using the calculation method; a second acquisition unit that acquires a representative motion vector based on a motion vector detected from images output from the image sensor; and a setting unit that sets an acquisition method for acquiring the representative motion vector by the second acquisition unit based on the calculation method.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a schematic configuration of an image capturing system according to an embodiment of the present disclosure.

FIG. 2 is a block diagram illustrating general configurations of image stabilization control units in a camera body and an interchangeable lens apparatus according to the embodiment.

FIG. 3 is a diagram explaining a first cooperative method according to the embodiment.

FIG. 4 is a diagram explaining a second cooperative method according to the embodiment.

FIGS. 5A to 5C are diagrams illustrating examples of divisions of motion vector detection areas according to the embodiment.

FIGS. 6A and 6B are diagrams explaining setting examples of motion vector detection areas according to the embodiment.

FIGS. 7A and 7B are diagrams explaining weights set on motion vector detection areas according to the embodiment.

FIGS. 8A to 8C are diagrams explaining correction gains for motion vector detection amounts according to the embodiment.

FIG. 9 is a flowchart illustrating image stabilization processing in the camera body according to the embodiment.

FIG. 10 is a flowchart illustrating image stabilization processing in the interchangeable lens apparatus according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

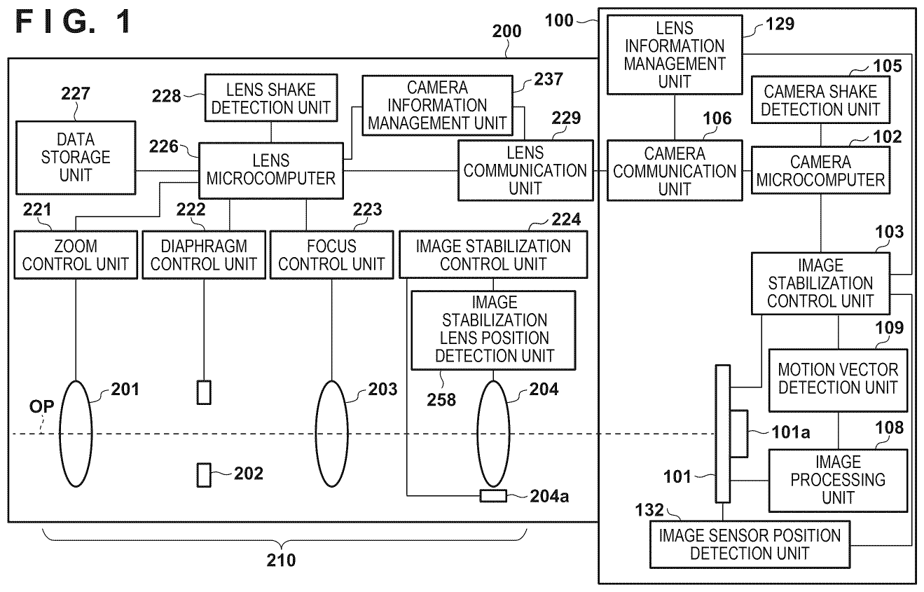

FIG. 1 is a block diagram illustrating a schematic configuration of an image capturing system according to this embodiment. The image capturing system includes a camera body 100 and an interchangeable lens apparatus (hereinafter referred to as an “interchangeable lens”) 200 that is detachably attached to the camera body 100. The camera body 100 may be a still camera or a video camera. This embodiment describes image stabilization in the image capturing system in which the interchangeable lens 200 is detachably attached to the camera body 100 (a so-called interchangeable lens camera).

First, the components of the camera body 100 will be described.

An image sensor 101 is, for example, an image sensor such as a complementary MOS (CMOS) image sensor. It captures an image of a subject by photoelectrically converting an optical image of the subject formed by light incident through an imaging optical system 210 of the interchangeable lens 200, and outputs an image signal. The image sensor 101 is configured to be movable in a direction perpendicular to the optical axis OP of the imaging optical system 210 by a shift mechanism 101a, and the image sensor 101 and the shift mechanism 101a function as an image stabilization unit. The image sensor 101 can, for example, shift within a plane perpendicular to the optical axis OP, or rotate around the optical axis OP within a plane perpendicular to the optical axis OP. The following explanation focuses on shifting the image sensor 101. The shift mechanism 101a has an actuator and can shift the image sensor 101 under control of an image stabilization control unit 103. The image signal output from the image sensor 101 is input to an image processing unit 108.

The image processing unit 108 performs various image processing on the input image signal to generate image data. The generated image data is displayed on a monitor (not shown) or recorded on a recording medium (not shown). The image data generated by the image processing unit 108 is also output to a motion vector detection unit 109.

The motion vector detection unit 109 uses image data of a plurality of images (a plurality of frames of image data) captured consecutively by the image sensor 101 at different timings and generated by the image processing unit 108 to detect motion information of feature points in the image data as motion vectors. The detection algorithm for detecting motion vectors from image data of a plurality of images may be any known algorithm, such as a correlation method or block matching method. The motion vector detection unit 109 generates a histogram of a plurality of motion vector amounts of the detected motion vectors obtained from the motion vector detection area, calculates the average value of the motion vector amounts in the bin of the histogram with the most concentrated distribution, and obtains one representative motion vector amount. The unit of the obtained representative motion vector amount is converted into the unit of angular velocity and used for image stabilization control, which will be described later. Image blur detection using motion vectors is more suitable for detecting camera shake components in a relatively low frequency range than image blur detection using an angular velocity sensor, which will be described later.

In this embodiment, the motion vectors detected by the motion vector detection unit 109 are used for image stabilization, but they may also be used for purposes other than image stabilization control. For example, the amount of movement of a subject to be tracked may be detected as a motion vector, and the detected motion vector may be used to perform subject tracking control. Furthermore, the detection value of an angular velocity sensor (described later) may be compared with the detection value of the motion vector, and an offset component may be removed from the detection value of the angular velocity sensor. Furthermore, the motion vector detection unit 109 may change the motion vector detection method depending on the control state of the camera. For example, the motion vector detection area, the weight set on each area in the motion vector detection area, or the correction gain by which the detection amount of the motion vector is multiplied may be changed. Details of the processing by the motion vector detection unit 109 will be described later.

A camera shake detection unit 105 is composed of inertial sensors such as an angular velocity sensor and an acceleration sensor, and detects shake of the camera body 100 caused by a user's hand shake or the like (hereinafter referred to as “camera shake”). A camera shake detection signal representing the detected camera shake is then output to the image stabilization control unit 103 via a camera microcomputer 102. In this embodiment, the camera shake detection unit 105 is an angular velocity sensor, and a case in which an obtained angular velocity signal is output as a camera shake detection signal will be described.

The camera microcomputer 102 controls the overall processing of the camera body 100. It is also capable of communicating with a lens microcomputer 226 via a camera communication unit 106 and a lens communication unit 229 in the interchangeable lens 200. The camera communication unit 106 has electrical contacts, and by connecting to the electrical contacts of the lens communication unit 229 of the attached interchangeable lens 200, communication is performed between the interchangeable lens 200 and the camera body 100.

A lens information management unit 129 holds and manages various types of information about the interchangeable lens 200 acquired through communication with the interchangeable lens 200 via the camera communication unit 106. The various types of information include optical characteristic information about an image stabilization lens 204 included in the interchangeable lens 200, correction position information and information about the movable range (upper limit of the moving amount) of the image stabilization lens 204.

The image stabilization control unit 103 of the camera body 100 functions as a control unit that controls IBIS by controlling the movement of the image sensor 101. The image stabilization control unit 103 calculates a shift amount (target image stabilization amount) of the image sensor 101 to reduce (correct) image blur caused by camera shake, based on the camera shake detection signal and the motion vectors detected by the camera shake detection unit 105 and the motion vector detection unit 109, respectively. Then, by controlling the actuator of the shift mechanism 101a based on the shift amount, the image sensor 101 is shifted by the calculated shift amount. In this manner, the image of the subject is moved on the image plane (sensor plane) of the image sensor 101, thereby enabling image stabilization (IBIS) by shifting the image sensor 101.

An image sensor position detection unit 132 is a position detection sensor such as a Hall sensor, and detects the position of the image sensor 101 and outputs the detected position to the image stabilization control unit 103.

Next, each component of the interchangeable lens 200 will be explained.

The imaging optical system 210 has a variable magnification lens 201, a diaphragm 202, a focus lens 203, and the image stabilization lens 204, which is an optical element that can change the position at which an image of a subject is formed.

A zoom control unit 221 can detect the position of the variable magnification lens 201 (hereinafter referred to as the “zoom position”) and varies the magnification by moving the variable magnification lens 201 in response to a zoom actuation command from the camera microcomputer 102. Information about the zoom position is transmitted to the camera body 100 via the lens microcomputer 226 and the lens communication unit 229. The transmitted zoom position may be information about the position of the variable magnification lens 201, or may be information about the focal length corresponding to the zoom position.

A diaphragm control unit 222 can detect the aperture diameter of the diaphragm 202 (hereinafter referred to as the “aperture position”) and adjusts the amount of light by actuating the diaphragm 202 in response to a diaphragm actuation command from the camera microcomputer 102. The diaphragm control unit 222 may detect and control the aperture position continuously, or may detect and control the aperture position discontinuously, such as fully open, two stops (intermediate), and one stop (minimum). Furthermore, the aperture position may be detected using the moving amount of the actuation mechanism that actuates the diaphragm 202. Information on the aperture position is transmitted to the camera body 100 via the lens microcomputer 226 and the lens communication unit 229.

A focus control unit 223 can detect the position of the focus lens 203 (hereinafter referred to as the “focus lens position”) and performs focus adjustment by actuating the focus lens 203 in response to a focus actuation command from the camera microcomputer 102. Information on the focus lens position is transmitted to the camera body 100 via the lens microcomputer 226 and the lens communication unit 229.

The image stabilization lens 204 is configured to be shiftable by a shift mechanism 204a in directions including a directional component perpendicular to the optical axis, and the image stabilization lens 204 and the shift mechanism 204a function as an image stabilization unit. That is, the image stabilization lens 204 is configured to be able to shift within a plane perpendicular to the optical axis and to rotate around a point on the optical axis as the rotation center. The following explanation focuses on the case where the image stabilization lens 204 is shifted. Shifting the image stabilization lens 204 changes the direction of the optical axis of the imaging optical system, thereby moving the position of the image of the subject formed on the image plane of the image sensor 101, thereby enabling image stabilization. The shift mechanism 204a has an actuator and is able to shift the image stabilization lens 204 under control of an image stabilization control unit 224 of the interchangeable lens 200.

A lens shake detection unit 228 is composed of inertial sensors such as an angular velocity sensor and an acceleration sensor, and detects shake of the interchangeable lens 200 caused by hand shake by the user or the like (hereinafter referred to as “lens shake”). A lens shake detection signal representing the detected lens shake is then output to the image stabilization control unit 224 via the lens microcomputer 226. Note that in a case where the interchangeable lens 200 is attached to the camera body 100, lens shake and camera shake are nearly identical, so the shake detected by the lens shake detection unit 228 is also referred to as “camera shake.” In this embodiment, the lens shake detection unit 228 is assumed to be an angular velocity sensor, and a case in which the obtained angular velocity signal is output as a lens shake detection signal will be described.

The image stabilization control unit 224 of the interchangeable lens 200 controls the movement of the image stabilization lens 204, thereby functioning as a control unit that controls OIS. The image stabilization control unit 224 calculates the shift amount of the image stabilization lens 204 to reduce (correct) image blur caused by lens shake, based on the lens shake detection signal detected by the lens shake detection unit 228. Then, by controlling the actuator of the shift mechanism 204a based on the shift amount, the image stabilization lens 204 is shifted by the calculated shift amount. This makes it possible to perform image stabilization (OIS) by shifting the image stabilization lens 204.

The image stabilization by shifting the image sensor 101 (IBIS) and the image stabilization by shifting the image stabilization lens 204 (OIS) are generally referred to as optical image stabilization. In this embodiment, whether or not to perform optical image stabilization can be set independently for IBIS and OIS. Note that whether or not to perform optical image stabilization may be set by the camera microcomputer 102 based on a user instruction, or may be set automatically based on various information such as the mode of the camera body 100.

An image stabilization lens position detection unit 258 is a position detection sensor such as a Hall sensor, which detects the position of the image stabilization lens 204 and outputs the detected position to the image stabilization control unit 224.

The lens microcomputer 226 controls the overall processing of the interchangeable lens 200. It is also capable of communicating with the camera microcomputer 102 via the lens communication unit 229 and the camera communication unit 106 of the camera body 100. The lens microcomputer 226 also functions as a transmission control unit that reads out information such as image circle information (described later) stored in a data storage unit 227 and transmits the image circle information, etc., to the camera body 100.

The lens communication unit 229 has electrical contacts, and by connecting to the electrical contacts of the camera communication unit 106 of the attached camera body 100, communication is performed between the interchangeable lens 200 and the camera body 100.

A camera information management unit 237 holds and manages various types of information about the camera body 100 acquired through communication with the camera body 100 via the lens communication unit 229. The various types of information include camera setting information, position information and information about the movable range of the image sensor 101.

The data storage unit 227 is a non-volatile storage unit that stores optical information such as the zoom range (variable range of focal length), focus range (focusable distance range), and variable range of aperture value of the imaging optical system 210.

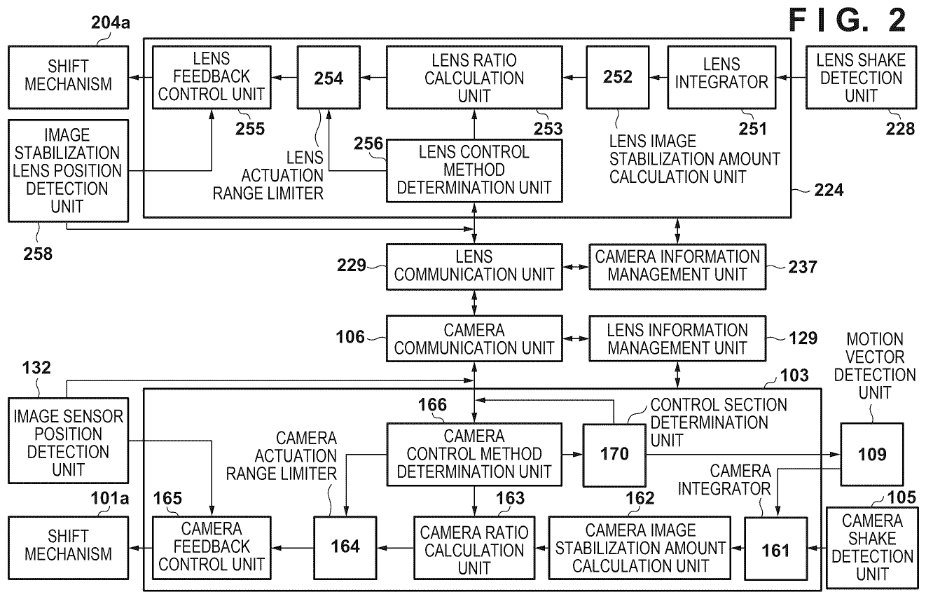

FIG. 2 is a block diagram illustrating the detailed configurations of the image stabilization control unit 103 of the camera body 100 and the image stabilization control unit 224 of the interchangeable lens 200. First, the configuration of the image stabilization control unit 103 of the camera body 100 will be described.

The image stabilization control unit 103 of the camera body 100 generates a shake detection signal by adding the camera shake detection signal from the camera shake detection unit 105 and the representative motion vector amount from the motion vector detection unit 109. Of camera shake, shake in a relatively high frequency range is suited to be detected by an angular velocity sensor, while shake in a relatively low frequency range is suited to be detected as a motion vector. Therefore, by adding the camera shake detection signal, which is the detection signal from the camera shake detection unit 105, and the representative motion vector amount, which is the detection signal from the motion vector detection unit 109, it is possible to detect camera shake over a wide frequency range. A camera integrator 161 of the image stabilization control unit 103 of the camera body 100 converts the input angular velocity signal into an angle signal by integrating it. In this embodiment, a pseudo-integral low-pass filter (hereinafter referred to as an “integral LPF”) is used as the camera integrator 161.

A camera image stabilization amount calculation unit 162 calculates the image stabilization amount for canceling the shake angle, taking into consideration the frequency band of the converted shake angle and the range in which the image sensor 101 can be moved. A specific example of this processing is to perform band-pass filtering that extracts from the input angle signal only a specific frequency band that is the target of image stabilization.

A camera control method determination unit 166 determines whether the cooperative control in which the IBIS and the OIS share image stabilization is performed in a first cooperative method or a second cooperative method. In this embodiment, if at least one of the camera body 100 and the interchangeable lens 200 does not support the second cooperative method, the first cooperative method is selected, and if both support the second cooperative method, the second cooperative method is selected.

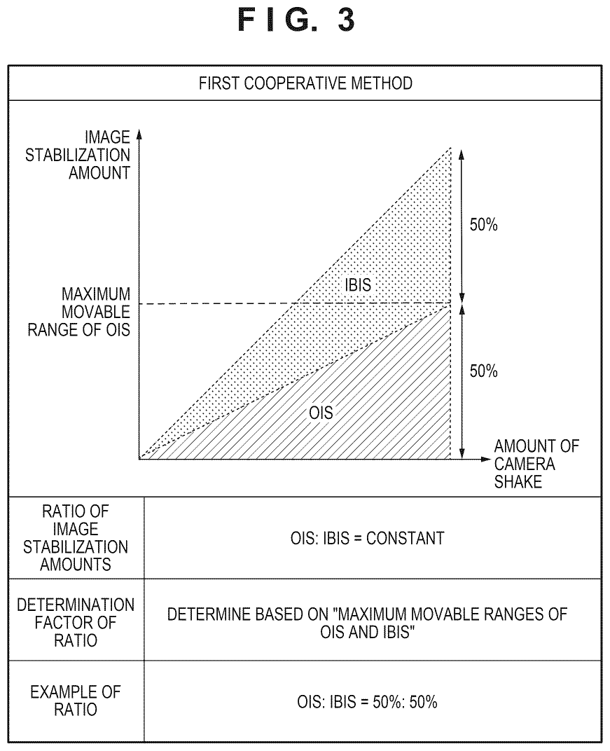

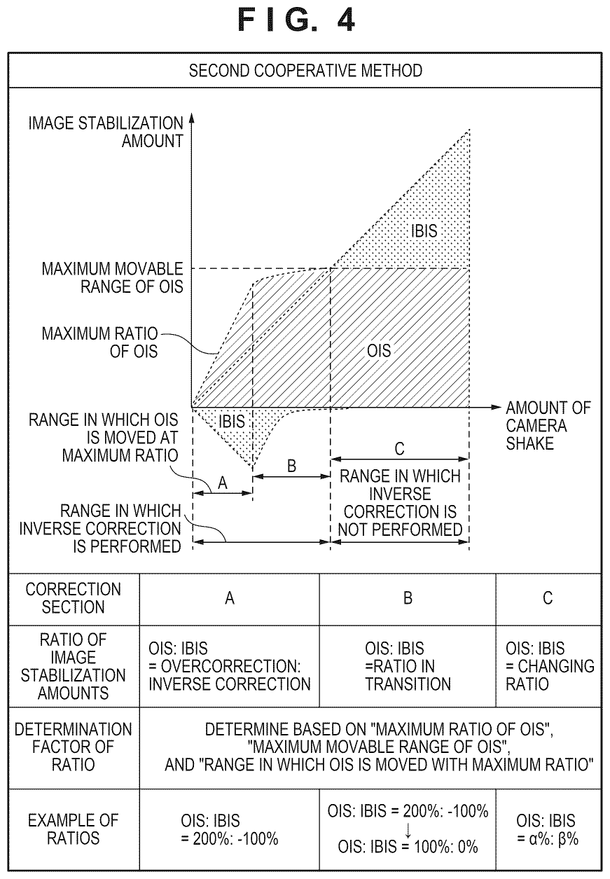

The first cooperative method and the second cooperative method will now be described with reference to FIGS. 3 and 4. FIG. 3 is a diagram illustrating the first cooperative method, and FIG. 4 is a diagram illustrating the second cooperative method. In the graphs of FIGS. 3 and 4, the horizontal axes represent the amount of camera shake, which indicates the angle signal obtained by integrating the angular velocity signal of camera shake detected by the camera shake detection unit 105 using the camera integrator 161, and the vertical axes represent the image stabilization amount. In a case of performing image stabilization, it is basically preferable that the amount of camera shake and the image stabilization amount are equal, because, by reducing the amount of camera shake, camera shake can be eliminated without any residual camera shake.

First, the first cooperative method will be described using FIG. 3. In the first cooperative method, the ratio of OIS to IBIS is constant regardless of the amount of camera shake, and the image stabilization amount assigned to the OIS and the image stabilization amount assigned to the IBIS increase as the amount of camera shake increases until they reach the end (upper limit) of the movable ranges of the OIS and IBIS. This ratio is determined based on the magnitudes (lengths) of the movable ranges of the OIS and IBIS. Note that the movable range here does not refer to the distance that the image stabilization lens 204 or the image sensor 101 can actually move, but rather refers to the distance that can cause relative movement between the subject image and the image plane of the image sensor 101 by moving the image stabilization lens 204 or the image sensor 101. FIG. 3 shows, as an example, a case where the movable ranges of the OIS and IBIS are the same, and the correction ratio of the OIS to the IBIS is always 50% regardless of the amount of camera shake. At this time, the direction of relative movement between the subject image and the image plane of the image sensor 101 caused by the OIS is the same as the direction of relative movement between the subject image and the image plane of the image sensor 101 caused by the IBIS, and the OIS and IBIS share the operation of reducing image blur caused by camera shake.

For example, if the image stabilization lens 204 moves the subject image upward when it is moved upward, the OIS moves the image stabilization lens 204 downward in a case where upward camera shake occurs, thereby moving the subject image downward relative to the image plane of the image sensor 101. At this time, the IBIS moves the image sensor 101 upward, thereby moving the subject image downward relative to the image plane of the image sensor 101. In other words, the image plane moves upward relative to the subject image. This method of moving the OIS and IBIS so that relative movement occurs at the same ratio and in the same direction regardless of the amount of camera shake is called the first cooperative method. In this case, the image stabilization amount assigned to the OIS and the image stabilization amount assigned to the IBIS do not exceed the amount of shake actually detected.

Next, the second cooperative method will be described with reference to FIG. 4. In the second cooperative method, in a section (sections A and B in FIG. 4) in which the amount of movement of the image stabilization lens 204 corresponding to the image stabilization amount required to correct the amount of camera shake is equal to or less than the length of the movable range of the image stabilization lens 204 (the length from the reference position to the movable end of the image stabilization lens 204), the image stabilization lens 204 is moved as the OIS with an image stabilization amount (excessive image stabilization amount) that exceeds the amount necessary to correct the amount of camera shake that occurs. In other words, in the sections A and B, the amount of shake that occurs can be corrected by the OIS alone. This control to move the image stabilization lens with an image stabilization amount that exceeds the amount necessary to correct the amount of camera shake that occurs is called overcorrection control. During this time, the IBIS performs inverse correction control to cancel the amount of image stabilization provided by the OIS that exceeds the amount necessary to correct the amount of camera shake that occurs, i.e., the excessive image stabilization amount. In this case, the relative moving directions between the subject image and the image plane of the image sensor generated by the OIS and IBIS are opposite each other. In this way, in the second cooperative method, overcorrection is performed by the OIS and the excessive image stabilization amount is canceled by the IBIS, which is called a first control method (cooperative control method).

On the other hand, if the image stabilization amount for reducing the amount of camera shake that occurs exceeds the length of the movable range of the image stabilization lens 204 and the OIS alone is no longer able to correct the amount of shake that occurs (section C), the IBIS corrects the amount of camera shake that cannot be completely corrected by the OIS. At this time, the moving direction of the image sensor 101 is a direction that reduces the movement of the subject image on the image sensor 101 that is caused by the amount of camera shake that has occurred, and the directions of relative movement between the subject image and the image plane of the image sensor 101 by the OIS and IBIS coincide. As described above, in the second cooperative method, a method used in a case where a magnitude of shake that cannot be completely corrected by the first control method occurs, and that controls the directions of relative movement between the subject image and the image plane of the image sensor generated by the OIS and IBIS so as to coincide, is called a second control method (cooperative control method).

During control with the first control method, if an amount of camera shake exceeding the amount corresponding to the boundary between the sections B and C is detected (that is, if the amount of camera shake changes from an amount less than a predetermined value to an amount more than the predetermined value), the system switches from the first control method, which performs the inverse correction, to the second control method, which does not perform the inverse correction. On the other hand, during control with the second control method, if an amount of camera shake less than the amount corresponding to the boundary between the sections B and C is detected, the system switches from the second control method, in which the OIS and IBIS perform correction in the same direction, to the first control method, which performs the inverse correction.

The control in each section is explained in detail below.

The section A is a section in which overcorrection control is performed in the OIS and inverse correction control is performed in the IBIS, and in particular, is a section in which the OIS is operated at its maximum ratio. In the example shown in FIG. 4, the maximum ratio is 200%, and the image stabilization amount is set to twice the amount of correction necessary to correct image blur caused by camera shake. In this case, because overcorrection by the OIS would cause image blur, the IBIS correction ratio is set to −100% so as to set the total of the OIS and IBIS correction ratios to 100%. Note that a correction ratio of −100% means that an image stabilization mechanism is actuated by an image stabilization amount that causes displacement of the image sensor 101 by the same amount in the same direction as image shake caused by camera shake. In other words, it means that an image sensor 101 is actuated by an image stabilization amount that doubles the image blur caused by camera shake.

The section B extends from the end point of the section A until the image stabilization amount for reducing the amount of camera shake that occurs exceeds the length of the movable range of the image stabilization lens 204. In the section B, the OIS correction ratio and the IBIS inverse image stabilization amount gradually decrease, that is, a section in which the absolute values of the OIS correction ratio and the IBIS correction ratio gradually decrease. In the example of FIG. 4, at the boundary between the sections A and B, the OIS correction ratio is 200%, and the IBIS correction ratio is −100%. Control is performed such that the absolute values of the correction ratios monotonically decrease from the boundary between the sections A and B to the boundary between the sections B and C, with the OIS correction ratio transitioning from 200% to 100% and the IBIS correction ratio transitioning from −100% to 0%. In this case, by performing the control so that the sum of the OIS and IBIS correction ratios is 100%, it is possible to correct shake without excess or deficiency.

In the section C, the OIS cannot correct shake any further, so the deficiency of the correction by the OIS is made up by the IBIS. During this period, the image stabilization amount of the OIS remains constant, and only the image stabilization amount of the IBIS increases. Therefore, the correction ratio between the OIS and IBIS does not remain constant during the section C; when the amount of camera shake is large, the IBIS correction ratio (β) increases and the OIS correction ratio (α) decreases. Even in this section, by controlling the sum of the OIS and IBIS correction ratios to be 100%, it is possible to correct shake without excess or deficiency.

The second cooperative method shown in FIG. 4 can reduce image blur at the periphery of an image compared to the first cooperative method.

For example, when shooting a moving image while carrying the camera body 100, significant shake occurs in the camera body 100 due to the impact of the photographer landing while walking, etc. In this case, the shake occurring in the camera body 100 is corrected by the OIS and IBIS. However, with the first cooperative method, the optimal image stabilization amount differs between the center of the image, where the image height is small, and the peripheral area, where the image height is high, and therefore, when optimal correction is performed for image blur in the center of the image, image blur in the peripheral area may become noticeable. This is particularly noticeable when shooting with a wide angle or when shooting a moving image. With the second cooperative method, it is possible to reduce such image blur in the peripheral area of the image.

The camera control method determination unit 166 determines whether to use the first cooperative method or the second cooperative method described with reference to FIGS. 3 and 4 to control the OIS and IBIS. There may be three or more cooperative methods, and the camera control method determination unit 166 may select a cooperative method from among the three or more cooperative methods.

Returning to the description of the image stabilization control unit 103 of the camera body 100 using FIG. 2, a camera ratio calculation unit 163 obtains the correction ratio of the IBIS when the sum of the image stabilization amounts assigned to the OIS and IBIS is adjusted to 100%, and multiplies the obtained ratio by a first image stabilization amount calculated by the camera image stabilization amount calculation unit 162 to obtain a second image stabilization amount. The correction ratio is obtained based on the cooperative method (the first cooperative method or the second cooperative method). When the second cooperative method is used, the correction ratio is obtained based on the detected amount of camera shake and data indicating the relationship between the amount of camera shake and the ratio, as shown in the graph of FIG. 4. Furthermore, since the first image stabilization amount corresponds to the total image stabilization amount of the IBIS and OIS, the second image stabilization amount of the shake correction assigned to the IBIS is calculated by multiplying the first image stabilization amount by the correction ratio assigned to the IBIS.

If the target position of the image sensor 101, which corresponds to the second image stabilization amount, exceeds the movable range, a camera actuation range limiter 164 performs limit processing and adjusts the image stabilization amount so that the target position does not exceed the movable range. The output of the camera actuation range limiter 164 becomes the final target image stabilization amount for the IBIS.

A camera feedback control unit 165 performs feedback control using the current position acquired by the image sensor position detection unit 132 so that the image sensor 101 follows a target position corresponding to the target image stabilization amount, and performs image stabilization control by actuating the image sensor 101 by the shift mechanism 101a. In this embodiment, the camera feedback control unit 165 performs PID control based on the current position and the target image stabilization amount. However, the feedback control method is not limited to PID control, and P control, PI control, or PD control may also be used.

When the camera control method determination unit 166 selects the second cooperative method, a control section determination unit 170 determines in which section of the control sections shown in FIG. 4 image stabilization control is being performed based on the current amount of camera shake (output of the camera integrator 161). Note that camera ratio calculation unit 163 also determines in which section image stabilization control is being performed based on the amount of camera shake and obtains the correction ratio, so the control section determination unit 170 may obtain that result. Conversely, the determination result of the control section determination unit 170 may be output to the camera ratio calculation unit 163, and the camera ratio calculation unit 163 may use this determination result to obtain the ratio.

Next, the configuration of the image stabilization control unit 224 of the interchangeable lens 200 will be described. The image stabilization control unit 224 of the interchangeable lens 200 receives an angular velocity signal as a shake detection signal from the lens shake detection unit 228. A lens integrator 251 of the image stabilization control unit 224 integrates the received angular velocity signal to convert it into an angle signal. In this embodiment, an integral LPF is also used for the lens integrator 251.

A lens image stabilization amount calculation unit 252 calculates an image stabilization amount to cancel the shake angle, taking into consideration the frequency band of the converted shake angle and the movable range of the image stabilization lens 204. A specific example of this processing is to perform band-pass filtering on the input angle signal that extracts only a specific frequency band that is the target of image stabilization.

Similarly to the camera control method determination unit 166, a lens control method determination unit 256 determines whether the cooperative control of the IBIS and OIS will be performed using the first cooperative method or the second cooperative method. The determination method is similar to that of the camera control method determination unit 166, and the lens control method determination unit 256 selects the second cooperative method in a case where both the camera body 100 and the interchangeable lens 200 support the second cooperative method. Note that instead of the lens control method determination unit 256 making the determination, the determination result may be acquired from the camera control method determination unit 166. Conversely, the lens control method determination unit 256 may determine the cooperative method and transmit the determination result to the camera body 100, thereby substituting the camera control method determination unit 166.

A lens ratio calculation unit 253 obtains the correction ratio of the OIS, given that the sum of the image stabilization amounts assigned to the IBIS and OIS is 100%, and calculates a fourth image stabilization amount by multiplying this ratio by a third image stabilization amount calculated by the lens image stabilization amount calculation unit 252. As with the camera ratio calculation unit 163, the correction ratio is obtained based on the cooperative method, and if the cooperative method is the second cooperative method, the correction ratio is obtained based on data indicating the relationship between the amount of camera shake and the detected amount of camera shake. Note that the lens ratio calculation unit 253 may obtain the correction ratio of the OIS in such a manner that the camera ratio calculation unit 163 also obtains the correction ratio of the OIS and transmits it to the lens ratio calculation unit 253, which then receives it. Alternatively, the camera ratio calculation unit 163 may transmit the correction ratio of the IBIS to the lens ratio calculation unit 253, and the lens ratio calculation unit 253 may obtain the OIS correction ratio based on the received correction ratio of the IBIS. Alternatively, the roles of the lens ratio calculation unit 253 and the camera ratio calculation unit 163 may be reversed, and the lens ratio calculation unit 253 may obtain the IBIS and OIS correction ratios and transmit the IBIS correction ratio to the camera body 100, or transmit the OIS correction ratio to the camera body 100.

If the target position of the image stabilization lens 204, which corresponds to the fourth image stabilization amount, exceeds the movable range, a lens actuation range limiter 254 performs limit processing and adjusts the image stabilization amount so as not to exceed the movable range. The output of the lens actuation range limiter 254 becomes the final target image stabilization amount for the OIS.

A lens feedback control unit 255 performs feedback control using the current position acquired by the image stabilization lens position detection unit 258 so that the image stabilization lens 204 follows the target position corresponding to the target image stabilization amount, and performs image stabilization control by actuating the image stabilization lens 204 by the shift mechanism 204a.

Next, the processing by the motion vector detection unit 109 will be described. The motion vector detection unit 109 determines the motion vector detection method based on the determination result of the control section determination unit 170. As described above, the second control method of the second cooperative method cannot optically reduce image blur in the peripheral area of the image as well as the first control method. Therefore, in a case where the motion vector detection unit 109 detects a motion vector, if the peripheral area of the image is included in the motion vector detection area, the image blur components in the peripheral area of the image will be detected as motion vectors, deteriorating the detection accuracy of the motion vector.

On the other hand, compared to the second control method, the first control method can optically reduce image blur in the peripheral area of the image, making it possible to detect motion vectors using an image in which image blur in the peripheral area is optically reduced. Therefore, the first control method allows the motion vector detection unit 109 to set the entire image, including the peripheral area, as the motion vector detection area. In this way, the first control method sufficiently reduces image blur in the peripheral area of the image, so by setting the entire image, including the peripheral area, as the motion vector detection area, the motion vector detection unit 109 can accurately detect motion vectors. That is, while the control is performed by the second control method, the motion vector detection unit 109 cannot set the entire image, including the peripheral area, as the motion vector detection area and detect motion vectors, whereas while the control is performed by the first control method, the motion vector detection unit 109 can set the entire image, including the peripheral area, as the motion vector detection area and detect motion vectors.

With the reasons described above, in this embodiment, in motion vector detection in the second cooperative method, the method of detecting a motion vector is determined based on the correction control sections (sections A to C) shown in FIG. 4.

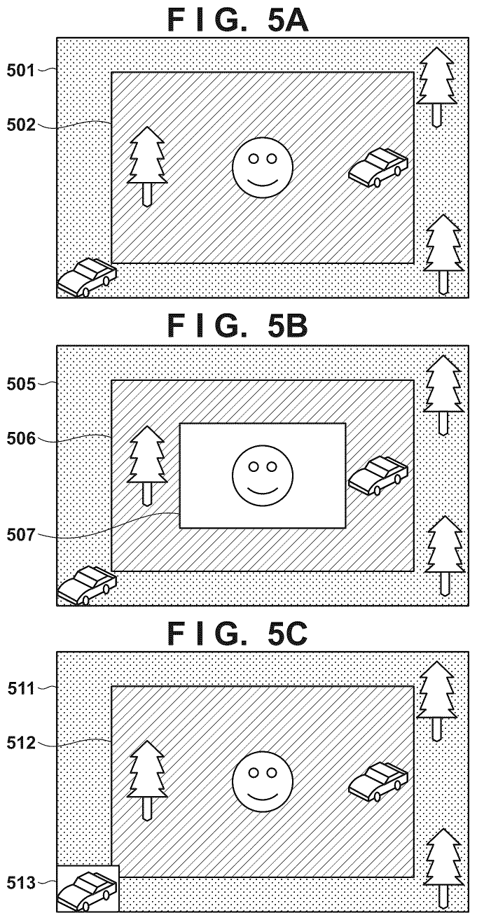

Next, a method for determining a motion vector detection method based on the correction control sections will be described. Four methods will be described here using divided portions of the motion vector detection area shown in FIGS. 5A to 5C as examples. Note that the representative motion vector will be obtained using the following motion vector detection methods, so the following motion vector detection methods can also be referred to as methods for obtaining a representative motion vector.

### Motion Vector Detection Method 1

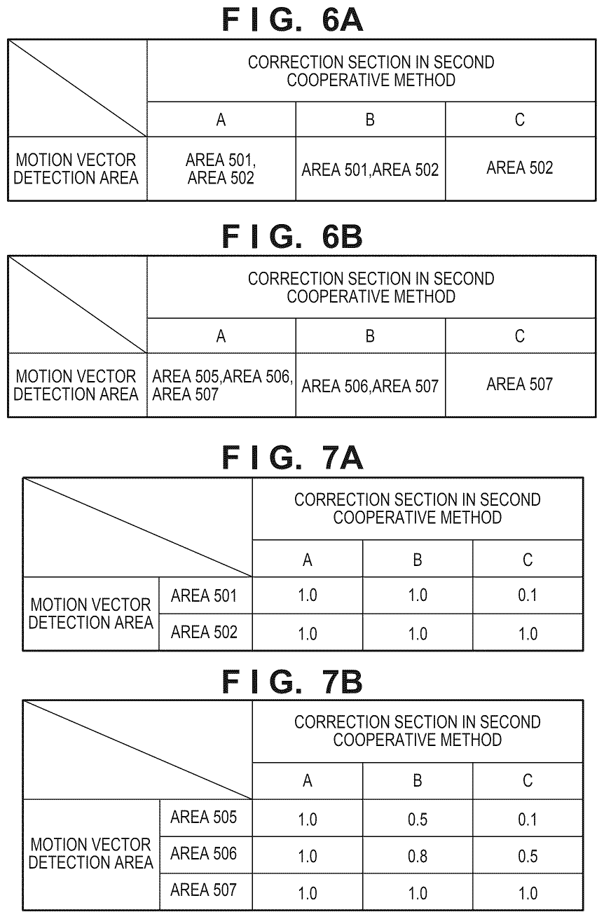

A motion vector detection method 1 will be explained using FIGS. 5A to 5C and FIGS. 6A and 6B.

The motion vector detection unit 109 obtains the determination result of the control section determination unit 170. Then, if the motion vector detection area is divided as shown in FIG. 5A, and if the motion vector detection unit 109 receives a determination result indicating the section A and the section B in FIG. 4 where the OIS and IBIS are being controlled using the first control method in which the inverse correction is performed, the motion vector detection unit 109 sets areas 501 and 502, i.e., the entire image, as the motion vector detection area, as shown in FIG. 6A, and detects motion vectors.

On the other hand, if the motion vector detection unit 109 receives a determination result from the control section determination unit 170 indicating the section C in FIG. 4 where the control is being performed by the second control method, the motion vector detection unit 109 sets only the area 502 as the motion vector detection area (the area 501 is not included in the motion vector detection area), as shown in FIG. 6A, and detects motion vectors.

Further, in a case where the motion vector detection area is as shown in FIG. 5B, for example, and if the motion vector detection unit 109 receives a determination result from the control section determination unit 170 indicating the section A in FIG. 4 where the control is being performed by the first control method, the motion vector detection unit 109 sets areas 505, 506, and 507, i.e., the entire image, as the motion vector detection area, as shown in FIG. 6B. If the motion vector detection unit 109 receives a determination result indicating the section B in FIG. 4, the motion vector detection unit 109 sets the areas 506 and 507 as the motion vector detection area. If the motion vector detection unit 109 receives a determination result indicating the section C in FIG. 4, the motion vector detection unit 109 sets only the area 507 as the motion vector detection area. The motion vector detection unit 109 then detects motion vectors in the set motion vector detection area.

### Motion Vector Detection Method 2

Next, a motion vector detection method 2 will be explained using FIGS. 5A to 5C and FIGS. 7A and 7B.

In the motion vector detection method 2, each of partial areas of the motion vector detection area is weighted. The weighting value for each partial area is calculated based on the above-mentioned determination results. Then, when generating a histogram of a plurality of motion vector detection amounts detected from each detection area, the motion vector detection unit 109 multiplies the motion vector detection amount of each detection area by its respective weighting value and aggregates the frequencies of the detection areas. For example, if the motion vector detection area is divided as shown in FIG. 5A, the weighting values are set for divided areas of the motion vector detection area as shown in FIG. 7A based on the determination result of the control section determination unit 170.

That is, in a case where the motion vector detection area is divided as shown in FIG. 5A, if a determination result obtained from the control section determination unit 170 indicates the section A and section B in FIG. 4 where the control is being performed using the first control method which performs the inverse correction, the motion vector detection unit 109 sets the weighting value for the portion of the motion vector detection area in the periphery of the image (the area 501 in FIG. 5A) to 1.0 so as to relatively increase the weight for that area, as shown in FIG. 7A.

On the other hand, in a case where the motion vector detection unit 109 receives a determination result obtained from the control section determination unit 170 indicating the section C in FIG. 4 where the control is being performed using the second control method, the motion vector detection unit 109 sets the weighting value for the portion of the motion vector detection area in the periphery of the image (the area 501 in FIG. 5A) to 0.1 to make it relatively small, as shown in FIG. 7A. Note that the portion of the motion vector detection area in the center of the image (the area 502 in FIG. 5A) has a small image height, and therefore is less affected by image blur, so the weighting value for the area is set to 1.0 regardless of the control section.

Further, in a case where the motion vector detection area is divided as shown in FIG. 5B, if the motion vector detection unit 109 receives a determination result from the control section determination unit 170 indicating the section A in FIG. 4 where the control is being performed using the first control method, the motion vector detection unit 109 sets the weighting value for the partial areas of the motion vector detection area in the peripheral area of the image (the areas 505 and 506 in FIG. 5B) to 1.0 as shown in FIG. 7B so as to relatively increase the weight. In a case where the motion vector detection unit 109 receives a determination result indicating the section B in FIG. 4, the motion vector detection unit 109 sets the weighting value for the area 505 to 0.5 and the weighting value for the area 506 to 0.8 so as to relatively reduce the weight for the partial area of the motion vector detection area in the peripheral area (the areas 505 and 506 in FIG. 5B) of the image. Since the image height of the area 506 is smaller than that of the area 505 and the effect of image blur is relatively small, the weighting value for the area 506 is set to a larger value than that for the area 505.

Furthermore, in a case where the motion vector detection unit 109 receives a determination result from control section determination unit 170 indicating the section C in FIG. 4 where the control is being performed using the second control method, the motion vector detection unit 109 sets the weighting value for the area 505 to 0.1 and the weighting value for the area 506 to 0.5 so as to relatively reduce the weight for the partial areas of the motion vector detection area in the peripheral area (the areas 505 and 506 in FIG. 5B) of the image as shown in FIG. 7B. The partial area of the motion vector detection area in the center of the image (the area 507 in FIG. 5B) is with a small image height and is less affected by image blur, so the weighting value is set to 1.0 regardless of the control section.

In this way, in a case where the motion vector detection unit 109 receives a determination result from control section determination unit 170 indicating the section C in FIG. 4 where the control is being performed using the second control method, the motion vector detection unit 109 relatively reduces the weight on the partial area of the vector detection area in the peripheral area (e.g., that area 501 in FIG. 5A) of the image. As a result, when the motion vector detection unit 109 generates a histogram, if the OIS and IBIS are being controlled in a control section in which image stabilization in the periphery of the image is weak, corresponding to the section C in FIG. 4, the proportion of motion vector detection amount in the periphery of the image can be made smaller than the proportion of motion vector detection amount in the center of the image, thereby improving the accuracy of motion vector detection.

### Motion Vector Detection Method 3

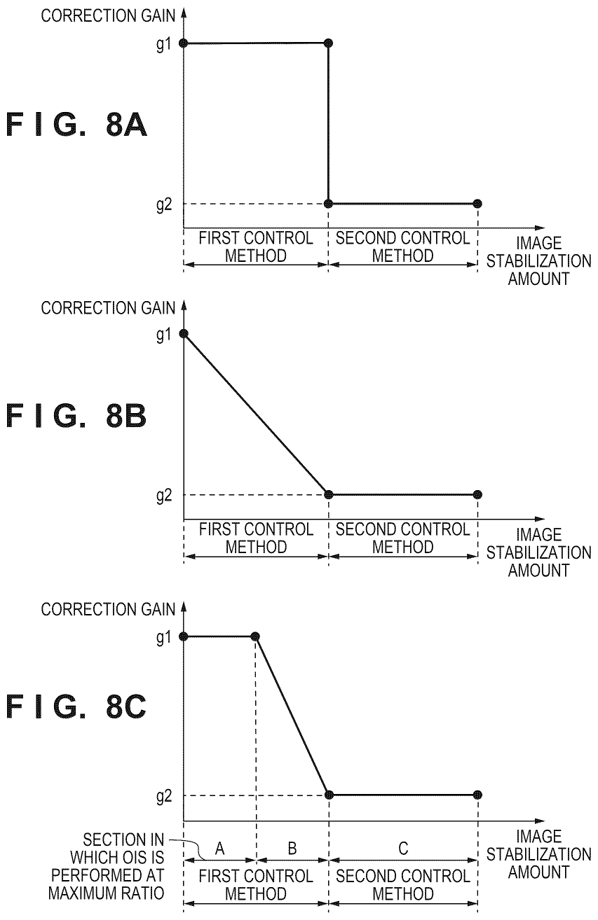

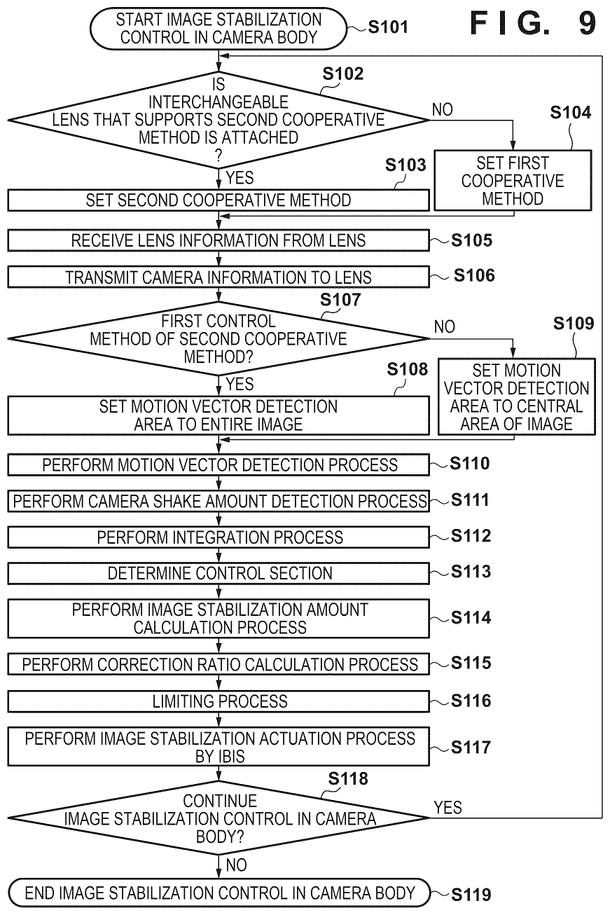

Next, a motion vector detection method 3 will be explained using FIGS. 5A to 5C and FIGS. 8A to 8C.

In the motion vector detection method 3, a gain to multiply the motion vector detection amount in the partial area of the motion vector detection area in the peripheral area of the image is changed. In this case, the correction gain g is used to multiply the motion vector detection amount in the partial area of the motion vector detection area in the peripheral area of the image.

As shown in FIG. 8A, for example, during control using the first control method, the correction gain is set to g1, and during control using the second control method, the correction gain is set to g2, with the magnitude relationship between the two gains being g1>g2. During control using the first control method, the motion vector detection amount in the partial area of the motion vector detection area in the periphery of the image is multiplied by the correction gain g1, and during control using the second control method, the motion vector detection amount in the partial area of the motion vector detection area in the periphery of the image is multiplied by the correction gain g2.

Further, as shown in FIG. 8B, the correction gain g may be varied according to the image stabilization amount in the section controlled by the first control method. In FIG. 8B, the correction gain g decreases from g1 to g2 in proportion to an increase in the image stabilization amount in the section controlled by the first control method.

Furthermore, as shown in FIG. 8C, in the section controlled by the first control method, the correction gain may be made different between a section (the section A in FIG. 4) in which the OIS is performed at the maximum ratio as described in FIG. 4 and a section (the section B in FIG. 4) in which the IBIS is used for correction by reducing the amount of inverse correction as the image stabilization amount increases. FIG. 8C illustrates an example in which the correction gain in the section A is set to g1 (a constant value), and in the section B, the correction gain is reduced from g1 to g2 in proportion to the increase in the image stabilization amount. Because the OIS cannot be performed at the maximum ratio in the section B, the effect of optical image stabilization (OIS, IBIS) in reducing image blur in the peripheral area of the image is reduced compared to the section A. Therefore, in the section B, the correction gain g for the motion vector detection amount is gradually reduced in proportion to the image stabilization amount. As a result, when image stabilization in the peripheral area of the image is weak, which corresponds to the section C in FIG. 4, the correction gain in the peripheral area of the image is reduced, thereby improving the detection accuracy of the motion vectors calculated by the motion vector detection unit 109.

### Motion Vector Detection Method 4

In the motion vector detection methods 1 to 3, the motion vector detection method used by the motion vector detection unit 109 is determined based on the image stabilization status of the peripheral area with large image height of the image. In contrast, a motion vector detection method 4 selects an arbitrary subject within the image and determines the motion vector detection method based on the image stabilization status of the selected arbitrary subject.

For example, suppose that the user selects as a subject a “vehicle” in an area 513 shown in FIG. 5C displayed on the camera screen. The subject may be selected by touching the screen with a finger or the like, by displaying a selection frame on the screen and operating a button such as a cross key on the camera, or by other methods. Then, image stabilization is performed so that image blur of the subject selected by the user is reduced.

When a user selects a subject located at a large image height, such as a selected subject (e.g., a “vehicle” in the area 513 in FIG. 5C), priority is given to reducing image blur of the subject selected by the user, even though this may increase image blur for subjects in areas other than the area including the selected subject (e.g., a “human face” in the area 512). That is, the image stabilization amount is calculated using the user-selected area as the reference for image stabilization, and image blur in the area is reduced more than in other areas. The image stabilization amount in this case can be calculated by adding a preset offset value according to the image height of the area to the image stabilization amount calculated using the center of the image as the reference for image stabilization. The method for detecting motion vectors in the motion vector detection unit 109 is determined based on the image blur correction state of the selected subject.

If the image blur of the selected subject (the “vehicle” in the area 513 in FIG. 5C) is small, the area 513 around the selected subject is set as the motion vector detection area. Alternatively, the weight for the partial area (the area 513) of the motion vector detection area around the subject may be increased, or in a case where the user selects a subject (for example, the “vehicle” in the area 513 in FIG. 5C) at a large image height, priority is given to reducing image blur of the subject selected by the user even though image blur of subjects in areas (for example, the “human face” in the area 512) other than the area including the selected subject may become large. In other words, the image stabilization amount is calculated using an arbitrary area selected by the user as the reference for image stabilization, and image blur in the arbitrary area is reduced more than in other areas. The image stabilization amount in this case can be calculated by adding a preset offset value according to the image height of the arbitrary area to the image stabilization amount calculated using the center of the image as the reference for image stabilization.

The motion vector detection unit 109 determines the method for detecting a motion vector based on the image stabilization status of the selected subject. If the image blur of the selected subject (the “vehicle” in the area 513 in FIG. 5C) is small, the area 513 around the selected subject is set as the motion vector detection area. Alternatively, the weight of the motion vector detection area around the subject (the area 513) may be set greater than those of other areas, or the correction gain of the motion vector detection area around the subject (the area 513) may be set greater than those of other areas. That is, while the motion vector detection methods 1 to 3 use the center of the image as the reference and set the peripheral area according to the distance from there (image height), the motion vector detection method 4 uses the position of the selected subject as the reference and sets the peripheral area according to the distance from the position of the subject. Therefore, if the selected subject is located near one of the four corners of the image, even an area near the center of the image may be set as the peripheral area. This improves the accuracy of detecting the motion vector of any subject selected by the user.

The motion vector detected by the above method may be used for image stabilization of the selected subject or for subject tracking control of the selected subject. Furthermore, in the motion vector detection method 4, the settings related to the motion vector of each area (detection area setting, weight, gain, etc.) are changed based on the position of the selected subject. Therefore, the motion vector detection method 4 may be applied in a case where the second cooperative method is not used (for example, when the first cooperative method is used, or when only one of the OIS and IBIS is performed, etc.).

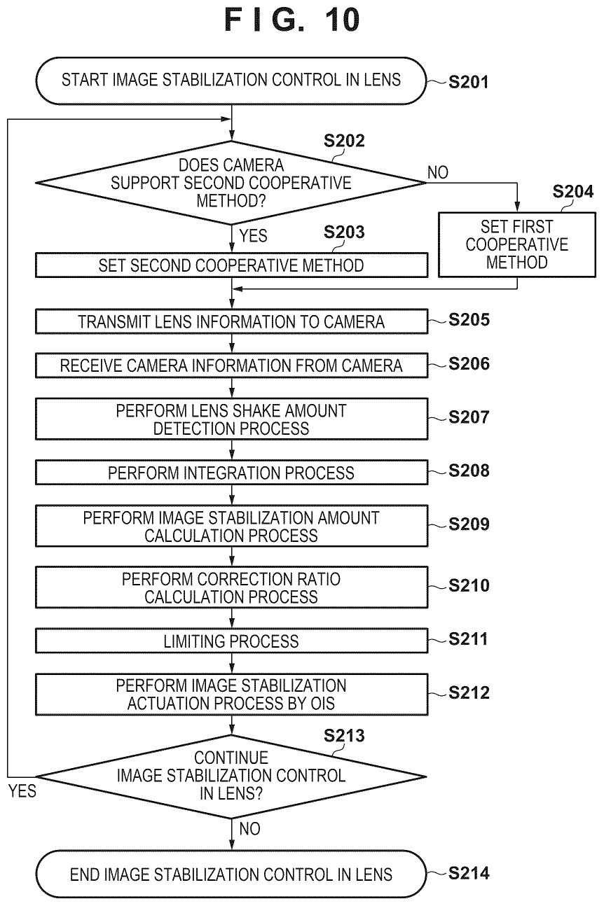

Next, the image stabilization processing performed in this embodiment will be described with reference to the flowcharts of FIG. 9 and FIG. 10. FIG. 9 is a flowchart of the image stabilization processing performed in the camera body 100 in this embodiment, and FIG. 10 is a flowchart of the image stabilization processing performed in the interchangeable lens 200 in this embodiment.

First, the image stabilization processing performed in the camera body 100 will be explained using FIG. 9. Unless otherwise specified, this processing is performed by the image stabilization control unit 103.

First, in step S101, the image stabilization control unit 103 receives instructions from the camera microcomputer 102 and starts image stabilization control.

In step S102, the camera control method determination unit 166 of the image stabilization control unit 103 determines whether the attached interchangeable lens 200 is an interchangeable lens that supports the second cooperative method, based on information indicating the model number of the interchangeable lens, etc. If the attached interchangeable lens supports the second cooperative method, the process proceeds to step S103, where it is determined that the following image stabilization control will be performed using the second cooperative method and the second cooperative method is set as the cooperative method to be used for the image stabilization control. If the attached interchangeable lens does not support the second cooperative method, the process proceeds to step S104, where it is determined that the following image stabilization control will be performed using the first cooperative method and the first cooperative method is set as the cooperative method to be used for the image stabilization control. Regardless of whether the process proceeds to step S103 or S104, the camera control method determination unit 166 outputs the determination result to the camera ratio calculation unit 163, the camera actuation range limiter 164, and the control section determination unit 170.

Once the cooperative method to be used for image stabilization control is set, the process proceeds to step S105, where the camera microcomputer 102 acquires lens information from the interchangeable lens 200 via the camera communication unit 106 and stores the lens information in the lens information management unit 129. The stored lens information has been described above, so a detailed description will be omitted.

Next, in step S106, the camera microcomputer 102 transmits the camera information to the interchangeable lens 200 via the camera communication unit 106. The transmitted camera information has been described above, so a detailed description will be omitted.

In step S107, the control section determination unit 170 determines whether the OIS and IBIS were controlled by the first control method of the second cooperative method in the previous cycle of the image stabilization processing (whether the control section corresponds to the section A or the section B in FIG. 4). In other words, this determination corresponds to the second cooperative method, and determines whether the current amount of camera shake is in the section that performs inverse correction, in which the OIS and IBIS cause to move the relative position between the subject image and the image sensor in opposite directions. This determination is made by referencing the result of step S113 in the previous cycle of the image stabilization processing. If it is determined that it is the first control method of the second cooperative method, the process proceeds to step S108. If it is determined that it is not the first control method of the second cooperative method, that is, in this embodiment, if it is determined that it is the first cooperative method or the second control method of the second cooperative method, the process proceeds to step S109.

In step S108, the motion vector detection unit 109 sets the motion vector detection area to the entire image, including the periphery of the image. On the other hand, in step S109, the motion vector detection unit 109 sets the motion vector detection area to only the center of the image. Once the motion vector detection area is set in step S108 or S109, the process proceeds to step S110.

Note that, in the detection area shown in FIG. 5A, the case where the motion vector detection area is set according to the motion vector detection method 1 is described here, but weighting values and gains may also be set as described above according to the motion vector detection method 2 or 3. Furthermore, in the case where the detection areas are as shown in FIG. 5B, the first control method is further divided into sections A and B. Furthermore, in a case where the motion vector detection area is set according to the motion vector detection method 4, the motion vector detection area is a predetermined area including the selected subject (for example, a range whose distance from the selected subject is less than a predetermined value).

In step S110, the motion vector detection unit 109 detects motion vectors in the motion vector detection area set in step S108 or S109. Details of motion vector detection have been described above and will not be repeated here.

In step S111, the image stabilization control unit 103 acquires the detection result from the camera shake detection unit 105. The acquired shake detection result is input to the camera integrator 161.

In step S112, the camera integrator 161 performs LPF processing on the signal obtained by adding the detection result input from the camera shake detection unit 105 and the detection result from the motion vector detection unit 109, thereby performing pseudo-integration.

In step S113, the control section determination unit 170 determines whether or not the control section is to control the OIS and IBIS using the first control method of the second cooperative method (whether the control section corresponds to the section A or section B in FIG. 4), and outputs the determination result to the camera ratio calculation unit 163. As described above, this determination is made based on the setting in step S103 or S104 and the magnitude of the camera shake amount.

In step S114, the camera image stabilization amount calculation unit 162 calculates the image stabilization amount based on the shake amount input from the camera integrator 161.

In step S115, the camera ratio calculation unit 163 obtains the correction ratio assigned to the camera body 100 based on the result of the determination by the camera control method determination unit 166. Furthermore, the camera ratio calculation unit 163 calculates the image stabilization amount for the IBIS by multiplying the obtained correction ratio by the image stabilization amount input from the camera image stabilization amount calculation unit 162. The method for obtaining the correction ratio is as described above, so details will be omitted, but in the case of the second control method, a correction ratio is obtained depending on the control section (any of the sections A to C).

In step S116, the camera actuation range limiter 164 performs limiting process if the target position of the image sensor 101 corresponding to the calculated image stabilization amount of the IBIS exceeds the limit of the movable range of the image sensor 101, and calculates the final target image stabilization amount of the IBIS.

In step S117, the camera feedback control unit 165 controls the shift mechanism 101a of the image sensor 101 based on the position of the image sensor 101 detected by the image sensor position detection unit 132 and the target image stabilization amount for the IBIS input from the camera actuation range limiter 164. In this way, the camera feedback control unit 165 controls the position of the image sensor 101 and performs image stabilization actuation process by the IBIS.

In step S118, the image stabilization control unit 103 of the camera body 100 determines whether or not to continue image stabilization control by the IBIS, and if so, the process returns to step S102. Note that, on the assumption that the attached interchangeable lens 200 remains unchanged, the process may return to step S105. In this case, the process may be configured to start again from step S102 when it is detected that the attached interchangeable lens 200 is changed. If it is determined not to continue image stabilization, for example, if the user turns off the image stabilization function using IBIS or the camera body 100 transitions to playback mode, this processing ends.

Next, the image stabilization processing in the interchangeable lens 200 will be explained using FIG. 10. Unless otherwise noted, this process is performed by the image stabilization control unit 224.

First, in step S201, the image stabilization control unit 224 receives an instruction from the lens microcomputer 226 and starts image stabilization control.

In step S202, the lens control method determination unit 256 of the image stabilization control unit 224 determines whether or not the attached camera body 100 supports the second cooperative method, based on information indicating the model number of the attached camera body 100, etc. If the attached camera body 100 supports the second cooperative method, the process proceeds to step S203, where it is determined that the following image stabilization control will be performed using the second cooperative method and the second cooperative method is set as the cooperative method to be used for the image stabilization control. If the attached camera body 100 does not support the second cooperative method, the process proceeds to step S204, where it is determined that the following image stabilization control will be performed using the first cooperative method and the first cooperative method is set as the cooperative method to be used for the image stabilization control. Regardless of whether the process proceeds to step S203 or S204, the lens control method determination unit 256 outputs the determination result to the lens ratio calculation unit 253 and the lens actuation range limiter 254. Instead of using the camera model number to determine whether the camera supports the second cooperative method, a determination result as to whether image stabilization control should be performed using the first cooperative method or the second cooperative method may be obtained from the camera body 100, and the cooperative method may be set according to the obtained determination result.

Once the cooperative method to be used in the image stabilization control is set, the process proceeds to step S205, where the lens microcomputer 226 transmits lens information to the camera body 100 via the lens communication unit 229. This corresponds to step S105 in FIG. 9.

Next, in step S206, the lens microcomputer 226 acquires camera information from the camera body 100 via the lens communication unit 229, and stores the acquired camera information in the camera information management unit 237. This corresponds to step S106 in FIG. 9.

In step S207, the image stabilization control unit 224 acquires the detection result from the lens shake detection unit 228. The acquired shake detection result is input to the lens integrator 251.

In step S208, the lens integrator 251 performs LPF processing on the input detection result from the lens shake detection unit 228 to perform pseudo-integration.

In step S209, the lens image stabilization amount calculation unit 252 calculates the image stabilization amount based on the shake amount input from the lens integrator 251. Details of the calculation of the image stabilization amount are as described above and will not be repeated here.

In step S210, the lens ratio calculation unit 253 obtains the correction ratio to be assigned to the interchangeable lens 200 based on the result of the determination by the lens control method determination unit 256. The obtained correction ratio is then multiplied by the image stabilization amount input from the lens image stabilization amount calculation unit 252 to calculate the image stabilization amount for the OIS. The method for obtaining the correction ratio is as described above, so details will be omitted, but in the case of the second control method, the correction ratio is obtained according to a control section (any of the sections A to C). For this reason, the result of the determination by the control section determination unit 170 obtained in step S206 is referenced.

In step S211, the lens actuation range limiter 254 performs limiting process if the target position of the image stabilization lens 204 corresponding to the calculated image stabilization amount of the OIS exceeds the limit of the movable range of the image stabilization lens 204.

In step S212, the lens feedback control unit 255 controls the shift mechanism 204a of the image stabilization lens 204 based on the position of the image stabilization lens 204 detected by the image stabilization lens position detection unit 258 and the target image stabilization amount of the OIS input from the lens actuation range limiter 254. In this way, the lens feedback control unit 255 controls the position of the image stabilization lens 204 and performs actuation process for the OIS.

In step S213, the image stabilization control unit 224 of the interchangeable lens 200 determines whether or not to continue image stabilization control by the OIS, and if yes, the process returns to step S202. On the assumption that the attached camera body 100 remains unchanged, the process may return to step S205. In this case, the process may be configured to start again from step S202 when it is detected that the attached camera body 100 is changed. If it is determined not to continue the image stabilization, for example, if the user has turned off the image stabilization function by the OIS, this processing ends.

In this embodiment, the target image stabilization amount for the IBIS is calculated in the camera body 100, and the target image stabilization amount for the OIS is calculated in the interchangeable lens 200. However, the target image stabilization amounts for both IBIS and OIS may be calculated in either the camera body 100 or the interchangeable lens 200.

Furthermore, in this embodiment, the target image stabilization amount is calculated based on the shake amount calculated by pseudo-integrating the signal obtained by adding together the detected motion vector amount and the detected amount of the angular velocity sensor, but the method for calculating the target image stabilization amount is not limited to this. For example, the target image stabilization amount may be calculated based on acceleration detected by an acceleration sensor, or the shake amount may be calculated using a plurality of pieces of information, such as information from motion vector detection, an angular velocity sensor, and an acceleration sensor.

In addition, in this embodiment, a camera system (image capturing system) configured with a camera body 100 and an interchangeable lens 200 that is detachable from the camera body has been described. However, this embodiment can also be applied to a lens-integrated camera as long as it has OIS and IBIS functions. Furthermore, as long as a device has a camera unit with OIS and IBIS functions, the present disclosure can also be applied to various electronic devices such as smartphones, tablets, wearable devices, and drones. Furthermore, for example, some or all of the processing performed by the image stabilization control unit 103 of the camera body 100 and the image stabilization control unit 224 of the interchangeable lens 200 in this embodiment may be performed by an external device or the cloud.

According to this embodiment, even if the amount of image blur varies depending on the image height, it is possible to accurately detect a motion vector using the subject image output from the image capturing apparatus. This effect is particularly noticeable in the case of shooting with a wide-angle lens, and even if the amount of image blur varies depending on the image height, it is possible to accurately detect a motion vector.

### Other Embodiments

The present disclosure may be applied to a system made up of a plurality of devices, or to an apparatus made up of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-208884, filed Nov. 29, 2024 which is hereby incorporated by reference herein in its entirety.

What is claimed is:

1. A control apparatus that controls image stabilization using a first correction unit that reduces image blur by actuating a correction lens included in an imaging optical system and a second correction unit that reduces image blur by actuating an image sensor that photoelectrically converts light incident via the imaging optical system and outputs an image signal, the apparatus comprising one or more processors and/or circuitry which function as:
a first acquisition unit that acquires an amount of shake detected by a shake detection unit;
a determination unit that determines a calculation method for correction amounts that are for controlling the first correction unit and the second correction unit based on the amount of shake and a control method of the first correction unit and the second correction unit;
a calculation unit that calculates the correction amounts for the first correction unit and the second correction unit based on the amount of shake using the calculation method;
a second acquisition unit that acquires a representative motion vector based on a motion vector detected from images output from the image sensor; and
a setting unit that sets an acquisition method for acquiring the representative motion vector by the second acquisition unit based on the calculation method.

2. The control apparatus according to claim 1, wherein the determination unit determines whether the first correction unit and the second correction unit support a cooperative control method that involves overcorrection in which the first correction unit is actuated excessively over the correction amount within a movable range of the first correction unit and inverse correction in which the second correction unit is actuated to cancel out an excessively corrected amount, and in a case where the determination unit determines that the first correction unit and the second correction unit support the cooperative control method, further determines the calculation method based on the amount of shake.

3. The control apparatus according to claim 2, wherein, in a case where the first correction unit and the second correction unit support the cooperative control method, the determination unit determines
a first calculation method, as the calculation method, that performs the overcorrection and the inverse correction in a case where the amount of shake can be corrected by performing the overcorrection and the inverse correction, and
a second calculation method, as the calculation method, that actuates the first correction unit at its maximum possible actuation amount and allocates a remaining of the correction amount to the second correction unit in a case where the correction amount corresponding to the amount of shake exceeds the movable range of the first correction unit.

4. The control apparatus according to claim 3, wherein,
in a case of the first calculation method, the setting unit sets the acquisition method for acquiring the representative motion vector based on a motion vector detected in an area including a first area including a center of the images and a second area in a peripheral area of the images, and
in a case of the second calculation method, the setting unit sets the acquisition method for acquiring the representative motion vector based on a motion vector detected in an area including the first area but not the second area.

5. The control apparatus according to claim 4, wherein
in a case of the first calculation method, the setting unit sets the acquisition method for acquiring the representative motion vector by assigning equal weights to motion vectors detected in the first area and the second area, and
in the case of the second calculation method, the setting unit sets the acquisition method for acquiring the representative motion vector by assigning a smaller weight to a motion vector detected in the second area than to a motion vector detected in the first area.

6. The control apparatus according to claim 4, wherein the setting unit sets the acquisition method for acquiring the representative motion vector by applying a higher gain to a motion vector in the first calculation method than in the second calculation method.

7. The control apparatus according to claim 2, wherein, in a case where the first correction unit and the second correction unit support the cooperative control method, the determination unit determines
a first calculation method, as the calculation method, that performs the overcorrection and the inverse correction in a case where the amount of shake can be corrected by performing the overcorrection within the movable range of the first correction unit and the inverse correction,
a second calculation method, as the calculation method, that performs the overcorrection and the inverse correction in a case where the amount of shake can be corrected by actuating the first correction unit by a maximum movable amount in the overcorrection and by performing the inverse correction;
a third calculation method, as the calculation method, that actuates the first correction unit by the maximum movable amount and allocates a remaining of the correction amount to the second correction unit in a case where the correction amount corresponding to the amount of shake exceeds the movable range of the first correction unit.

8. The control apparatus according to claim 7, wherein
in a case of the first calculation method, the setting unit sets the acquisition method for acquiring the representative motion vector based on a motion vector detected in an area including a first area including the center of the images, a second area that is closer to periphery of the images than the first area, and a third area that is even closer to the periphery of the images than the second area,
in a case of the second calculation method, the setting unit sets the acquisition method for acquiring the representative motion vector based on a motion vector detected in an area including the first area and the second area, and
in a case of the third calculation method, the setting unit sets the acquisition method for acquiring the representative motion vector based on a motion vector detected in the first area.

9. The control apparatus according to claim 7, wherein
in a case of the first calculation method, the setting unit sets the acquisition method for acquiring the representative motion vector by assigning equal weights to motion vectors detected in an area including a first area including the center of the images, a second area that is closer to periphery of the image than the first area, and a third area that is even closer to the periphery of the images than the second area,
in the case of the second calculation method, the setting unit sets the acquisition method for acquiring the representative motion vector by assigning a smaller weight to a motion vector detected in the second area than to a motion vector detected in the first area, and assigning a smaller weight to a motion vector detected in the third area than to a motion vector detected in the second area, and
in the case of the third calculation method, the setting unit sets the acquisition method for acquiring the representative motion vector by assigning a smaller weight to a motion vector detected in the second area than to a motion vector detected in the first area, and assigning a smaller weight to a motion vector detected in the third area than to a motion vector detected in the second area, wherein the weights assigned to the motion vectors detected in the second area and the third area are smaller than the weights assigned to the motion vectors detected in the second area and the third area in the second calculation method.

10. The control apparatus according to claim 7, wherein
the setting unit sets the acquisition method for acquiring the representative motion vector by applying a lower gain to a motion vector in a case of the second calculation method than in a case of the first calculation method, and
the setting unit sets the acquisition method for acquiring the representative motion vector by applying a lower gain to a motion vector in the case of the third calculation method than in a case of the second calculation method.

11. The control apparatus according to claim 1 further comprising an operation unit that allows a user to select an arbitrary area in the image,
wherein, in a case where an area is selected, the setting unit sets the acquisition method for acquiring the representative motion vector based on a motion vector detected in the selected area, regardless of the calculation method.

12. The control apparatus according to claim 1, wherein the calculation unit calculates the correction amounts for the first correction unit and the second correction unit further using the representative motion vector.

13. The control apparatus according to claim 1, wherein the one or more processors and/or circuitry further function as a second calculation unit that calculates an actuation amount for tracking a subject using the representative motion vector.

14. The control apparatus according to claim 2, wherein, in a case where at least one of the first correction unit and the second correction unit does not support the cooperative control method, the setting unit sets a predetermined acquisition method for acquiring the representative motion vector regardless of the calculation method.

15. A control apparatus that controls image stabilization by actuating at least one of a correction lens included in an imaging optical system and an image sensor that photoelectrically converts light incident through the imaging optical system and outputs an image signal, comprising:
an operation unit that allows a user to select an arbitrary area in an image output from the image sensor as a reference for the image stabilization; and
one or more processors and/or circuitry which function as:
an acquisition unit that acquires a representative motion vector based on motion vectors detected in a plurality of areas of images output from the image sensor after the image stabilization is performed; and
a setting unit that changes settings relating to the motion vectors detected in the plurality of areas according to a position of the selected arbitrary area.

16. An image capturing apparatus comprising:
a control apparatus that controls image stabilization using a first correction unit that reduces image blur by actuating a correction lens included in an imaging optical system and a second correction unit that reduces image blur by actuating an image sensor that photoelectrically converts light incident via the imaging optical system and outputs an image signal, the apparatus comprising one or more processors and/or circuitry which function as:
a first acquisition unit that acquires an amount of shake detected by a shake detection unit;
a determination unit that determines a calculation method for correction amounts that are for controlling the first correction unit and the second correction unit based on the amount of shake and a control method of the first correction unit and the second correction unit;
a calculation unit that calculates the correction amounts for the first correction unit and the second correction unit based on the amount of shake using the calculation method;
a second acquisition unit that acquires a representative motion vector based on a motion vector detected from images output from the image sensor; and
a setting unit that sets an acquisition method for acquiring the representative motion vector by the second acquisition unit based on the calculation method; and
the image sensor.

17. An image capturing system comprising:
an image capturing apparatus comprising:
a control apparatus that controls image stabilization using a first correction unit that reduces image blur by actuating a correction lens included in an imaging optical system and a second correction unit that reduces image blur by actuating an image sensor that photoelectrically converts light incident via the imaging optical system and outputs an image signal, the apparatus comprising one or more processors and/or circuitry which function as:
a first acquisition unit that acquires an amount of shake detected by a shake detection unit;
a determination unit that determines a calculation method for correction amounts that are for controlling the first correction unit and the second correction unit based on the amount of shake and a control method of the first correction unit and the second correction unit;
a calculation unit that calculates the correction amounts for the first correction unit and the second correction unit based on the amount of shake using the calculation method;
a second acquisition unit that acquires a representative motion vector based on a motion vector detected from images output from the image sensor; and
a setting unit that sets an acquisition method for acquiring the representative motion vector by the second acquisition unit based on the calculation method; and
the image sensor; and
the imaging optical system.

18. A control method for controlling image stabilization using a first correction unit that reduces image blur by actuating a correction lens included in an imaging optical system and a second correction unit that reduces image blur by actuating an image sensor that photoelectrically converts light incident via the imaging optical system and outputs an image signal, the method comprising:
acquiring an amount of shake detected by a shake detection unit;
determining a calculation method for correction amounts that are for controlling the first correction unit and the second correction unit based on the amount of shake and a control method of the first correction unit and the second correction unit;
calculating the correction amounts for the first correction unit and the second correction unit based on the amount of shake using the calculation method;
acquiring a representative motion vector based on a motion vector detected from images output from the image sensor; and
setting an acquisition method for acquiring the representative motion vector by the second acquisition unit based on the calculation method.

19. A control method for controlling image stabilization by actuating at least one of a correction lens included in an imaging optical system and an image sensor that photoelectrically converts light incident through the imaging optical system and outputs an image signal, comprising:
acquiring a representative motion vector based on motion vectors detected in a plurality of areas of images output from the image sensor after the image stabilization is performed; and
changing settings relating to the motion vectors detected in the plurality of areas according to a position of an arbitrary area selected by a user from an image output from the image sensor as a reference for the image stabilization.
